(19) United States
(12) Patent Application Publication
(10) Pub. No.: US 2005/0124338 A1
(43) Pub. Date: Jun. 9, 2005

(54) Network supported selection of service provider when roaming

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/730,429

(22) Filed: Dec. 8, 2003

(51) Int. Cl. H04Q 7/20

(52) U.S. Cl. 455/432.1

(57) ABSTRACT

In general terms, one embodiment of the method is for selecting, by a mobile terminal, a roaming service provider in a telecommunications network, when the mobile terminal is roaming. The method has the steps of: communicating between a mobile terminal and current roaming service providers for a current location of the mobile terminal; providing to the mobile terminal, at least upon detecting a registration message from the mobile terminal, respective roaming service provider information associated with the current roaming service providers; selecting, based on the roaming service provider information, a respective one of the current roaming service providers; and connecting subsequent call(s) associated with the mobile terminal using the selected respective roaming service provider. The system implements the method.

### TECHNICAL FIELD

The present invention relates to wireless telephony in general, and, more particularly, to a method and system that supports roaming service provider selection when a mobile terminal is roaming.

### BACKGROUND OF THE INVENTION

Wireless telephones, which include both cellular telephones and the higher frequency personal communication devices are growing in numbers and also shrinking in size and weight. The growth in numbers is influenced by the convenience and the per call cost of wireless telephones with respect to pagers and wire line telephones or coin telephones for completing calls, especially when the user is away from home or office.

Typical wireless communication networks, such as those operating in accordance with the Digital Enhanced Cordless Telecommunications (DECT) standard, generally have a plurality of radio base stations, which may be connected to a mobile switching center, which, in turn, may be connected to, or integral with a Private Branch Exchange (PBX). Each base station covers a limited area, generally called a cell, within which a wireless communication link can be established with a mobile terminal such as a cell phone. A call in progress can be handed over from one base station to another while the mobile terminal is moving in the coverage area of the network.

A plurality of communication networks, such as networks installed at geographically spread sites of a company or public wireless networks each covering a particular city, for example, may form a telecommunication system to which a user or subscriber may have acquired access rights. The several networks of a system may operate in a so-called stand-alone or in a mutually interconnected configuration. In the latter case using the Public Switched Telephone Network (PSTN) or private or leased lines for the coupling of the networks, for example.

The home network of a user is in general the network at which subscriber specific information of a user is registered such as access rights, information for billing purposes, etc. The home network is in general the network in the coverage area of which a user lives or works and in which the mobile terminal is used for the greater part. In the other networks used by the subscriber, the subscriber is then regarded as a visitor.

When roaming to a different (visited) network, subscriber data is not known to the new network and, in the case of a telecommunication system having interconnected networks, the relevant data must be transferred by the telecommunication system from the home network database to the visited network database whenever the user is registered at a visited network, for example. In another embodiment the visited network has to set up inquiry calls to the home network to fetch the relevant data on a case-by-case basis, for example.

Generally, one of the networks is designated the home network of a user. In his home network the user is registered as a subscriber. The home network is in general the network in the coverage area of which a user lives or works and in which the telephone is used for the greater part. In the other networks the user is then regarded as a visitor.

Although different roaming services may operate in a common area, a subscriber may only utilize the roaming service that the subscriber's own service has a contract with. However, this prevents the subscriber from selecting, for example, a roaming service that may be less expensive or that may have a higher quality of service.

Thus it is a drawback of the prior art that a subscriber cannot choose a roaming service from a plurality of roaming services that are available in a given area. There is a need in the prior art for a system that supports roaming service provider selection when the mobile terminal is roaming.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

In general terms, one embodiment of the present method is for selecting, by a mobile terminal, a roaming service provider in a telecommunications network, when the mobile terminal is roaming. The method has the steps of: communicating between a mobile terminal and current roaming service providers for a current location of the mobile terminal; providing to the mobile terminal, at least upon detecting a registration message from the mobile terminal, respective roaming service provider information associated with the current roaming service providers; selecting, based on the roaming service provider information, a respective one of the current roaming service providers; and connecting subsequent call(s) associated with the mobile terminal using the selected respective roaming service provider.

Also, in general terms, one embodiment of the present system is for allowing a mobile terminal to select a roaming service provider in a telecommunications network, when the mobile terminal is roaming. The system has: a mobile terminal that is operatively connected to a telecommunication network, the mobile terminal having a display; a call controller in the telecommunication network for controlling a call for the mobile terminal; a plurality of service providers in the telecommunication network, each of the service providers having respectively at least one cell in which the service provider is operational; each of the roaming service providers having respective roaming service provider information; and roaming service module in the service provider's system, the roaming service module operatively connected to at least the call controller.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of one embodiment of a mobile switching center, base station and mobile terminal for use with the present method and system.

FIG. 2 illustrates overlapping cells of a plurality of service providers for a roaming service provider.

FIG. 3 illustrates a more detailed block diagram illustrative of a mobile switching center, base station, and mobile terminal according to one embodiment of the present method and system.

FIG. 4 illustrates a general flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

A typical wireless communication network has three distinct elements: a mobile switching center, a plurality of base stations, which are installed throughout an area to be covered and connect directly to the mobile switching center, and mobile terminals, which connect over a wireless link, also called an air interface, to the base stations. Each base station provides service to a given area, called a cell, which is surrounded and/or overlapped by other cells of other radio base stations, i.e. a so-called multi-cell approach.

The radius of indoor cells typically ranges from 10 m to 100 m, whereas the radius of outdoor cells typically ranges from 200 m up to 5000 m. Users may set up and receive calls via the mobile switching center in each of the cells covered by a base station. A call in progress is handed over from one base station to another while a user is moving in the coverage area of the network.

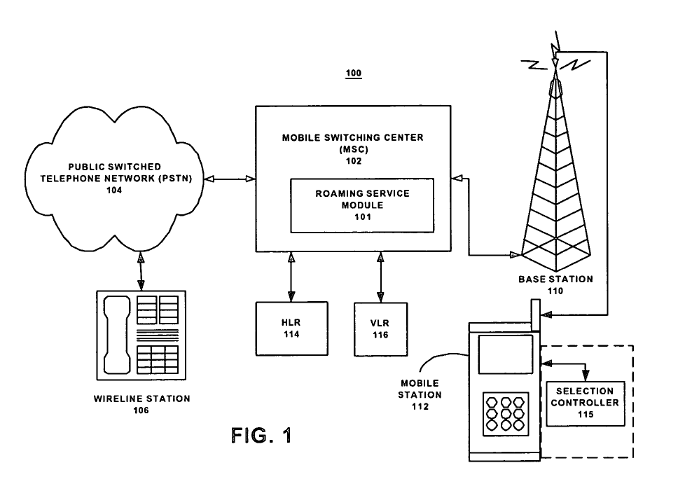

Referring to FIG. 1, a system 100 is depicted that supports roaming service provider selection when the mobile terminal is roaming. The mobile terminal may also be referred to as mobile phone, a cell phone, mobile handset, or car phone. The system 100 has a mobile switching center (MSC) 102. The system 100 may be, or may be part of, one or more of a telephone network, a local area network (“LAN”), the Internet, and a wireless network. In the depicted embodiment, a public switched telephone network (PSTN) 104 is connected to the MSC 102. The PSTN 104 routes calls to and from mobile terminals via the MSC 102. The PSTN 104 also routes calls from and to wireline stations 106. The MSC 102 is also connected to one or more base stations (BS) 110. Each of the base stations 110 communicates with mobile terminal(s) 112 in its service area (cell). The PSTN 104 generally can be implemented as a worldwide voice telephone network accessible to all those with telephones and access privileges (e.g., AT&T long distance network).

Each of the mobile terminals 112 may have associated home location registers (HLR) 114 where data about each of the mobile terminals 112 resides. Some of the mobile terminals 112 may be remotely located from their home location, and in that case, a visiting location register (VLR) 116 is set up locally for each mobile terminal 112 that is visiting in its service area. HLR 114 can be implemented as a permanent SS7 database utilized in cellular networks, such as, but not limited to, for example, AMPS (Advanced Mobile Phone System), GSM (Global System for Mobile Communications), and PCS.

HLR 114 may be utilized generally to identify/verify a subscriber, and also contains subscriber data related to features and services. HLR 114 is generally utilized not only when a call is being made within a coverage area supported by a cellular provider of record, but also to verify the legitimacy and to support subscriber features when a subscriber is away from his or her home area. VLR 116, on the other hand, may be implemented as a local database maintained by the cellular provider whose territory is being roamed. Mobile terminal 112 may be implemented as a cellular device, personal communication device, short message service device or wireless communications device (e.g., a wireless personal digital assistant).

The MCS 102 may have, or be operatively connected to, components of a system that supports roaming service for the mobile terminal that is roaming (for example, roaming service module 101 in the MCS 102 and service provider selection controller 115 in the mobile terminal 112).

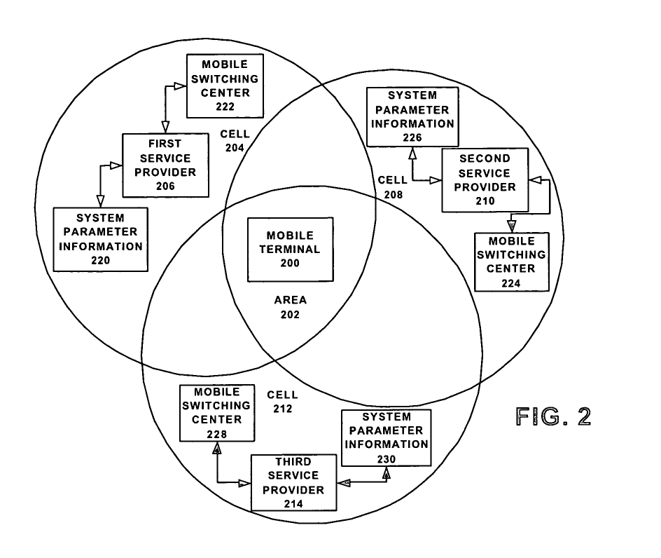

Referring to FIG. 2, a roaming mobile terminal or station 200 may be currently located in an area 202. This area 202, for example, may lie within cell 204 of a first service provider 206, within cell 208 of a second service provider 210, and within cell 212 of a third service provider 214. Each of the service providers 206, 210, 214 has associated therewith a respective mobile switching center 222, 224, 228 and respective system parameter information 220, 226, 230. In the prior art the telecommunication system may have an arrangement with the first service provider 206, and the mobile terminal 200 can only be tuned to the first service provider 206. However, with the present method and system, the subscriber of the mobile terminal 200 may select any one of the three service providers 206, 210, 214.

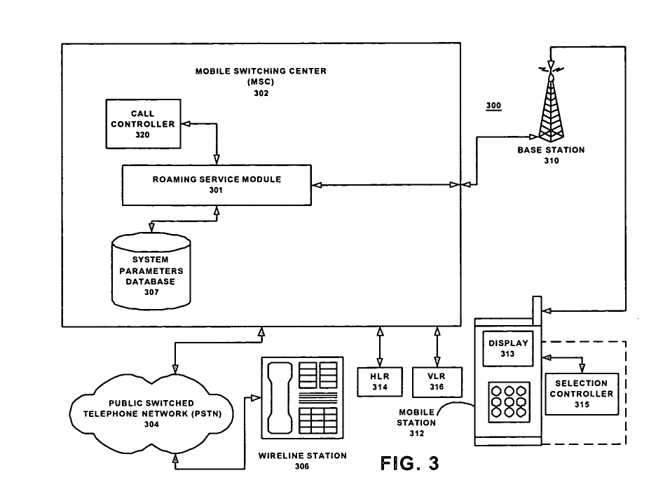

Referring to FIG. 3, a system 300 is shown that is illustrative of a mobile switching center 302 operatively connected to PSTN 304, base station 310 (which may be one of a plurality of base stations), and mobile terminal 312 (which may be one of a plurality of mobile terminals) according to one embodiment of the present method and system. The PSTN 304 routes calls to and from mobile users through the MSC 302, in addition to routing calls from and to wireline stations 306. The MSC 302 may be connected to one or more base stations 310. As depicted, the base station 310 communicates through the air to mobile terminal 312, which may be of a cellular telephone type or of the wider bandwidth personal communication device type. Mobile terminals 312 may be wireless handsets or automobile mounted stations. At least the MSC 302 and the base station 310 are part of a telecommunication network. The MSC 302 has operatively connected thereto a VLR 316 and a HLR 314 that interface with the mobile terminal 312.

An embodiment of the system for providing, by a telecommunications network, roaming service provider selection when a mobile terminal is roaming, may have the following elements.

The MSC 302 may have a call controller 320 that controls a call for the mobile terminal 312. The subscriber, via a mobile terminal service provider selection controller 315 in the mobile terminal 312, may select a roaming service provider in the telecommunications network, when the mobile terminal is roaming. The system 300 may have the mobile terminal 312 operatively connected, via a base station 310, to the MSC 302 in the telecommunication network. There may be a plurality of service providers in the telecommunication network, each of the service providers having respectively at least one cell in which the service provider is operational (see FIG. 2).

When the mobile phone is currently in one or more cells of the service providers, the mobile phone is in communication with each of the service providers as is known in the art. The mobile phone receives respective roaming service provider information from each of the service providers. Roaming service provider information may comprise pricing, data rates, push to talk, signal strength, etc that are stored in the system parameters database. A roaming service module 328 in the MSC 302 is operatively connected to the call controller 320.

Upon moving outside the home service provider's coverage area, , the mobile terminal 312 tries to register itself to all the roaming service providers and each roaming service provider information is displayed on the display 313 at the mobile terminal 312. The subscriber of the mobile terminal 312 then selects one of the service providers (such as service provider 311) in the telecommunication network 300 for a current location of the mobile terminal 312. A respective one (such as, service provider 311) of the current roaming service providers may be selected via the selection controller 315 at the mobile terminal 312 based on the displayed roaming service provider information. The selection of the respective current roaming service provider 315 is communicated to MSC 302 of service provider 311, the mobile terminal 312 is tuned to the selected service provider 311, and the call controller 320 will connect subsequent calls associated with the mobile terminal 312 using the selected respective roaming service provider 311 or based on the mobile terminal's further instruction.

The subsequent calls associated with the mobile terminal 312 may be one of an incoming call and an outgoing call. The selected respective roaming service provider 311 may be used for subsequent calls associated with the mobile terminal 312 while the mobile terminal 312 is within a cell of the selected respective roaming service provider 311. Alternatively, a respective roaming service provider 311 may be re-selected for each subsequent call associated with the mobile terminal. The subscriber of the mobile terminal 312 may instruct the mobile terminal 312 whether to always use a currently selected service provider or to re-select a service provider for future calls.

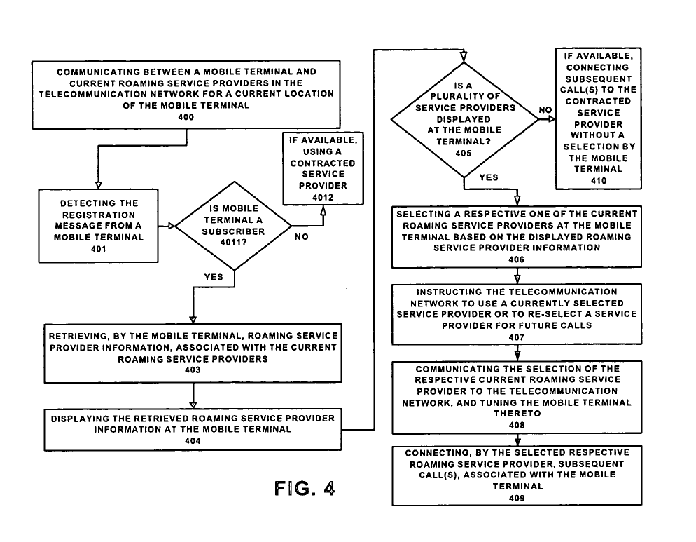

FIG. 4 is a block diagram depicting an embodiment of the present method. In very general terms, this embodiment of the method may have the steps of: communicating between a mobile terminal and current roaming service providers in the telecommunication network for a current location of the mobile terminal; detecting registration message from the mobile terminal (step 401); determining if the mobile terminal subscribes to a “service provider selection while roaming” feature (step 4011); if the mobile terminal does not subscribe, using the contracted service provider and tuning the mobile terminal to the contracted service provider (step 4012); retrieving, if the mobile terminal does subscribe, current roaming service provider information in a telecommunication network for a current location of the mobile terminal (step 403 ); displaying the retrieved roaming service provider information at the mobile terminal (step 404); selecting, if a plurality of service providers are displayed at the mobile terminal (step 405), a respective one of the current roaming service providers at the mobile terminal based on the displayed roaming service provider information (step 406); instructing the telecommunication network to use a currently selected service provider or to re-select a service provider for future calls (step 407); communicating the selection of the respective current roaming service provider to the telecommunication network (step 408); and connecting, by the selected respective roaming service provider, the subsequent call(s), associated with the mobile terminal (step 409). If there is only one service provider (usually a contracted service provider), the subsequent call(s) is connected to this contracted service provider without a selection by the mobile terminal (step 410).

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A method for selecting, by a mobile terminal, a roaming service provider in a telecommunications network, when the mobile terminal is roaming, the method comprising the steps of:
communicating between a mobile terminal and current roaming service providers for a current location of the mobile terminal;
providing to the mobile terminal, at least upon detecting registration message from the mobile terminal, respective roaming service provider information associated with the current roaming service providers;
selecting, based on the roaming service provider information, a respective one of the current roaming service providers; and
connecting subsequent call(s) associated with the mobile terminal using the selected respective roaming service provider.

2. The method of claim 1 wherein the roaming service provider information is at least one of pricing, data rates, push to talk, signal strength.

3. The method of claim 1 wherein the subsequent call(s) associated with the mobile terminal is one of an incoming call and an outgoing call.

4. The method of claim 1, wherein the selecting, by a mobile terminal, of a roaming service provider in the telecommunications network, when the mobile terminal is roaming, is a feature of the telecommunications network, and wherein the method further comprises, the step of determining, upon detecting the registration message from the mobile terminal, if the mobile terminal has subscribed to the feature, and if the mobile terminal has not subscribed, then one of connecting the subsequent call(s) via a contracted roaming service provider or not connecting the subsequent call(s), and, if the mobile terminal has subscribed, proceeding to the step providing to the mobile terminal respective roaming service provider information.

5. The method of claim 1 wherein the method further comprises, using the selected respective roaming service provider for subsequent calls associated with the mobile terminal while the mobile terminal is within at least one cell of the selected respective roaming service provider.

6. The method of claim 1 wherein the method further comprises re-selecting a respective roaming service provider for each subsequent call associated with the mobile terminal.

7. A method for selecting, by a mobile terminal, a roaming service provider in a telecommunications network, when the mobile terminal is roaming, the method comprising the steps of:
communicating between a mobile terminal and current roaming service providers for a current location of the mobile terminal;
providing to the mobile terminal, at least upon detecting registration message from the mobile terminal, respective roaming service provider information associated with the current roaming service providers;
displaying the roaming service provider information at the mobile terminal;
selecting, at the mobile terminal and based on the displayed roaming service provider information, a respective one of the current roaming service providers;
communicating the selection of the respective current roaming service provider to the telecommunication network and tuning the mobile terminal to the selected roaming service provider; and
connecting, by the selected respective roaming service provider, subsequent call(s) associated with the mobile terminal.

8. The method of claim 7 wherein the subsequent call(s) associated with the mobile terminal is one of an incoming call and an outgoing call.

9. The method of claim 7 wherein the method further comprises, using the selected respective roaming service provider for subsequent calls associated with the mobile terminal while the mobile terminal is within at least one cell of the selected respective roaming service provider.

10. The method of claim 7 wherein the method further comprises re-selecting a respective roaming service provider for each subsequent call associated with the mobile terminal.

11. The method of claim 7, wherein the selecting, by a mobile terminal, of a roaming service provider in the telecommunications network, when the mobile terminal is roaming, is a feature of the telecommunications network, and wherein the method further comprises, the step of determining, upon occurrence of a call associated with the mobile terminal, if the mobile terminal has subscribed to the feature, and if the mobile terminal has not subscribed, then one of connecting the subsequent call(s) via a contracted roaming service provider or not connecting the call(s), and, if the mobile terminal has subscribed, proceeding to the step providing to the mobile terminal respective roaming service provider information.

12. A system for allowing a mobile terminal to select a roaming service provider in a telecommunications network, when the mobile terminal is roaming, the system comprising:
a mobile terminal that is operatively connected to a telecommunication network, the mobile terminal having a display;
a call controller in the telecommunication network for controlling a call for the mobile terminal;
a plurality of service providers in the telecommunication network, each of the service providers having respectively at least one cell in which the service provider is operational;
each of the roaming service providers having respective roaming service provider information; and
respective roaming service module in a respective system of each of the service providers , the roaming service module operatively connected to at least the call controller;
wherein, upon detecting the registration message from the mobile terminal, respective roaming service provider information associated with the current roaming service providers is provided to the mobile terminal and displayed, wherein a respective one of the current roaming service providers is selected based on the displayed roaming service provider information, wherein the selection of the respective current roaming service provider is communicated to the telecommunication network and the mobile terminal is tuned to the selected roaming service provider; and wherein subsequent call(s) is connected to the selected respective roaming service provider.

13. The system of claim 12 wherein the subsequent call(s) associated with the mobile terminal is one of an incoming call and an outgoing call.

14. The system of claim 12 wherein the selected respective roaming service provider is used for subsequent calls associated with the mobile terminal while the mobile terminal is within at least one cell of the selected respective roaming service provider.

15. The system of claim 12 wherein a respective roaming service provider is re-selected for each subsequent call associated with the mobile terminal.
